(19) United States
(12) Patent Application Publication
(10) Pub. No.: US 2013/0304542 A1
(43) Pub. Date: Nov. 14, 2013

(54) SYSTEM AND METHOD FOR OBTAINING DATA FROM A DATABASE

(71) Applicant: James H. POWELL, Maineville, OH (US)

(72) Inventor: James H. POWELL, Maineville, OH (US)

(21) Appl. No.: 13/736,168

(22) Filed: Jan. 8, 2013

Related U.S. Application Data
(63) Continuation-in-part of application No. 13/469,422, filed on May 11, 2012.

(51) Int. Cl. G06Q 30/02

(52) U.S. Cl. CPC G06Q 30/0203
USPC 705/7.32

(57) ABSTRACT

A method of collecting input from individuals comprising searching a database containing individual consumer data, assigning a unique customer key to each individual consumer data and removing the identifying characteristics from the individual consumer's data with a computer having a memory and a processor operating a privacy filter to provide de-identified individual consumer data, maintaining a confidential record of each individual consumer's identifying characteristics associated with the unique customer key. De-identified individual consumer data are analyzed to define members of a target group. An electronic communication including a survey is passed through a linker/delinker to link contact information associated with the unique customer key of a member of the target group, sending the electronic communication to a member of the target group. A response from the member is received and passed through the privacy filter to associate the response with the unique customer key.

### CROSS-REFERENCE TO RELATED APPLICATION

This application is a Continuation-in-Part of U.S. patent application Ser. No. 13/469,422 filed on May 11, 2012, the disclosure of which is incorporated herein by reference in its entirety.

### FIELD OF THE INVENTION

This invention relates to a system and method for obtaining perspective and collecting information from individuals, health records, and other information sources. Specifically, this invention relates to a system and method for designing a clinical trial using information from electronic health records and input from members of the community and to a system and method for obtaining confidential information from and through the use of a commercial database.

### BACKGROUND OF THE INVENTION

Sponsors of clinical trials typically distribute feasibility questionnaires to potential investigators requesting information on their access and ability to recruit the desired patient population for a clinical trial. Such surveys can be inaccurate in estimating patient availability and can be biased by investigators' interest in securing a clinical trial for which they receive substantial grants. As many as 70% of investigators underperform in clinical trials by failing to meet patient enrollment goals. And, as many as 1 in 10 investigators fail to enroll a single patient. Sponsors typically incur an initial cost of $35,000 or more to develop each of the trial sites, in addition to redundant investigator sites that are required to compensate for poor performers. Additionally, regulatory requirements for maintaining and monitoring underperforming investigator sites who have enrolled one or more patients, but less than the agreed goal, contribute significantly to the cost of clinical trials. Clinical trials pivotal to medicine approvals can be delayed months due to poor recruitment These delays negatively impact market exclusivity period, return on investment for product development, overall costs of healthcare, and availability of important treatments. What is needed is a more efficient method for designing clinical trials and for recruiting clinical trial subjects. Commercial databases, such as grocery frequent shopper programs, pharmacy databases, online retail databases, bank customer databases, and financial databases contain detailed information about the habits of particular shoppers. That information, while typically maintained confidentially by the owner, can provide much information on shopper habits that may be used to distribute surveys, recruit focus groups, target coupons and implement and maintain shopper loyalty programs. While maintaining the confidentiality of the databases is important to the database owner and consumers, utilizing the information through a de-identifying algorithm can benefit both.

### SUMMARY OF THE INVENTION

This invention relates to a method of collecting input from individuals comprising searching a database containing a plurality of individual consumer data, assigning a unique customer key to each individual consumer's data and removing the individual's identifying characteristics from the individual consumer's data with a computer having a memory and a processor operating a privacy filter to provide de-identified individual consumer data, maintaining a confidential record of each individual's identifying characteristics associated with the unique customer key, analyzing the de-identified individual consumer data to define members of a target group, passing an electronic communication including a survey through a linker/delinker to link contact information associated with the unique customer key of a member of the target group, sending the electronic communication to the member of the target group, and receiving a response from the member of the target group, wherein said response is passed through the privacy filter to associate the response with the unique customer key.

This invention further relates to a system for designing a customer loyalty program comprising a database including de-identified individual consumer data, a search page configured to receive a search query and return a list of individuals matching said query from said database to define members of a target group, a privacy filter for keeping confidential each individual's identifying characteristics from the researcher until said individual authorizes disclosure of said individual's identifying characteristics, a survey provided to a member of the target group for identifying potential barriers to customer loyalty program participation, and a survey receiver for collecting responses from the survey of the member of the target group.

### BRIEF DESCRIPTION OF THE DRAWINGS

FIG. 1 is a block diagram showing a method of designing a clinical trial and recruiting clinical trial subjects according to the invention.

FIG. 2 is a schematic showing a flow chart and computer with a memory and processor according to the invention.

FIG. 3 is a schematic showing a security module according to the invention.

FIG. 4 is a flowchart showing the operation of the security module of FIG. 3.

FIG. 5 is a block diagram showing a method of anonymizing EHRs and conducting surveys according to the invention.

FIG. 6 is an exemplar screen of a search engine according to the invention.

FIG. 7 is a schematic showing a query and analysis according to the invention

FIG. 8 is an exemplar survey according to the invention.

FIG. 9 is a block diagram showing a method of identifying an investigator according to the invention.

FIG. 10 is a block diagram showing another method of identifying an investigator according to the invention.

FIG. 11 is a block diagram showing a method of designing a clinical trial according to the invention.

FIG. 12 is a block diagram showing a method of obtaining and anonymizing consumer information according to the invention.

FIG. 13 is a schematic showing another flow chart and computer with a memory and processor according to the invention.

FIG. 14 is a schematic showing another security module according to the invention.

FIG. 15 is a flowchart showing the operation of the security module of FIG. 14.

FIG. 16 is a schematic showing a query and analysis according to the invention.

### DETAILED DESCRIPTION OF THE INVENTION

A system and method of designing a research studies and recruiting subjects for research studies and clinical trials will without offending the privacy considerations of an individual, facilitate investigators searching of pertinent records concerning prospective research subjects to locate the individuals that best fulfill the research protocol associated with validating hypotheses, confirming therapeutic benefit, and attaining answers to questions raised in such research. Additionally, the system and method can facilitate the investigator contacting those individuals who best fulfill such research protocol (including healthy controls where desired), while also taking into account the privacy considerations of each such records subject.

The systems and methods in this application can be useful for a variety of research studies. For example, a researcher may employ the systems and methods described in this application to evaluate the incidents of a certain disease among a specific demographic, age or geographic population. One type of research study discussed in detail in this patent application is a clinical trial and the researcher who designs a clinical trial is a clinical trial designer.

Privacy concerns and inability or unwillingness to follow through on trial requirements have historically been a major reason for subjects not volunteering for clinical trial participation or for not completing a clinical trial. These concerns may be alleviated through the system and method described herein. Accordingly, a well-ordered system and method of recruiting subjects for research studies and clinical trials will, without offending the privacy considerations of a records subject allow clinical investigators and research organizations to contact individuals to request access to pertinent information as well as copies of pertinent records regarding the individual. The system and method disclosed herein can complement systems for identifying and making contact with prospective research subjects by allowing researchers or clinical trial designers to secure electronic records and information from individuals. Additionally, the system and method disclosed herein can complement systems for identifying and making contact with prospective research subjects by facilitating individuals to learn about clinical trials and research investigations that are most likely to be of interest to them, and by establishing their privacy considerations in an efficient, economical and reliable manner.

Other patent applications have disclosed and described methods for developing and designing clinical trials and recruiting subjects for clinical trials. Patent applications 2009/0112629, 2010/0250285, 2011/0258000, 2010/0088245, and 2010/0070306 are incorporated into this application in their entirety.

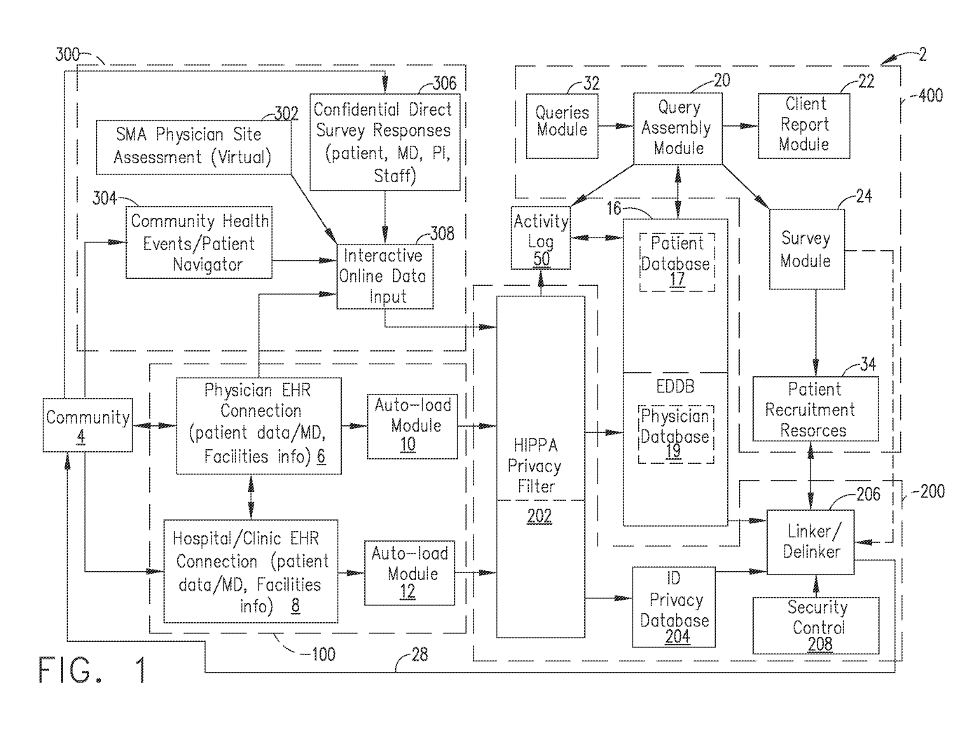

FIG. 1 shows a clinical trial design system 2. FIG. 1 depicts a community 4, an electronic health records (EHR) module 100, a security module 200, an input data module 300, and a query and analysis module 400.

A community 4 includes members of the general community, which may also be referred to as the general population. Typically, during visits to a health care provider, a community member has data related to their medical conditions, diagnosis, and treatment stored on EHRs. The EHRs may include all notes and observations taken during office visits, lab test shown in the EHR module 100, this data for individuals stored can be stored in a physician's (e.g. traditional doctor's office's) EHRs 6 and in a hospital's EHRs 8. In addition to the physician and hospital EHR sources, other EHR sources, such as government and insurance records, could also be used. The hospital could be a traditional hospital, a clinic, an outpatient hospital or facility, or any other type of facility offering medical care to patients that keeps or develops EHRs for or on its clients. Auto-load modules 10 and 12 load patient data from the EHRs to a HIPAA privacy filter 202 that de-identifies the data by removing patient identifying features such as name, address, email addresses and other identifying characteristics and assigns a unique patient key to the data.

The security module 200 includes the HIPAA privacy filter 202, an ID privacy database 204, security control 208, and a linker/delinker 206. The ID privacy database 204, security control 208, and the linker/delinker 206 may be incorporated in the HIPAA privacy filter 202. The autoload modules 10 and 12 pass the EHR data through the HIPAA privacy filter, which anonymizes the data by removing identifying characteristics, assigns a unique patient key to the data, and forwards the data to an Epidemiology and Demographics Database (EDDB) 16. The EDDB may include an EDDB patient database 17 for storing patient data and an EDDB physician database 19 for storing physician data that may be useful in selecting physicians to serve as investigators. The HIPAA privacy filter 202 also loads the unique patient key associated with each individual's records to an ID privacy database 204 that is part of the security module 200. The ID privacy database 204 stores and maintains the confidentiality of the unique patient key associated with each individual EHR record for the purpose of re-identifying the individual if and when future contact with an individual associated with a unique patient key is desired. Thus, the patient's information on the EDDB patient database is kept in compliance with HIPAA regulations and is kept confidential and private unless and until, a patient authorizes the release of their identifying characteristics.

A data input module 300 includes a physician site assessment 302, a community health events and patient navigator 304, a confidential survey response receiver 306, and an interactive data input module 308.

An analysis and questioning module 400 includes a Query Assembly Module (QAM) 20, a client report module 22, a surveying module 24, and a patient recruitment resource 34. Various queries can be drafted in the query module 32 and presented to the EDDB database through the QAM 20, In one example, a trial designer can submit a query to the QAM for all individuals having a specific medical condition, such as diabetes. The QAM then searches and retrieves from the EDDB the list of individuals, identified by the unique patient keys, who have diabetes, their medical information, and non-identifying data. The individuals who meet the query criteria are members of what is known as a target group. The QAM can then output a client report 22 listing those individuals. Other outputs could include only the number of individuals meeting the query limitations.

Once defining a target group, a trial designer may create a survey in the survey module 24 for members of the target group. The designer drafts the survey and selects the unique keyed patients who are members of the target group to whom the survey should be sent. The survey can be sent to the entire target group or only to certain members in the target group. The survey is sent through the linker/delinker 206 which links the unique patient key with the member, and sends the survey by way of an electronic communication or transmission 28 to the member of the target group, The electronic transmission 28 may be wired, such as through the internet, or it may be wireless, such as to a smart phone, or both.

As shown in FIG. 1, the trial design system 2 may also include an activity log 50 for logging all transactions performed HIPAA privacy filter, autoload modules, interactive data input, QAM module, and any other modules that are or may be a part of the system. The activity log 50 therefore provides a means of auditing substantially all the activity of the trial design system 2.

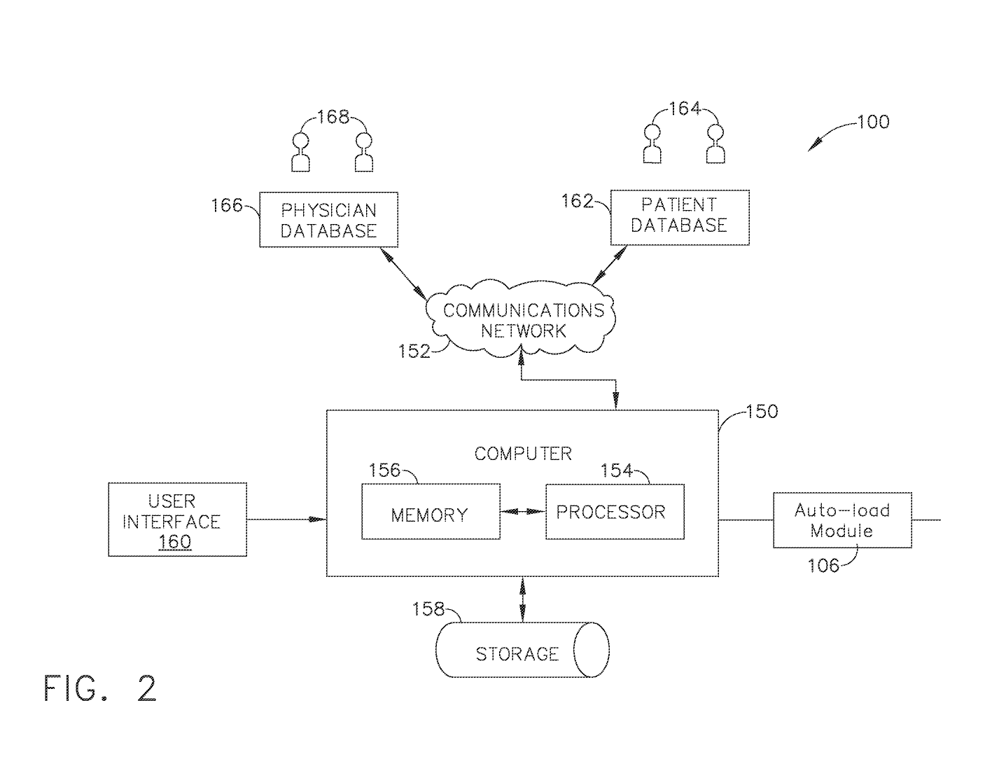

FIG. 2 is a block diagram of one example of an EHR module 100 for computerized loading of EHRs in the EDDB. FIG. 2 also includes a computer architecture used in the clinical trial design system. The example of FIG. 2 includes a computer 150 coupled to a communications network 152, such as the Internet or wired connection. In this example, the computer 150 includes a processor 154 that executes or interprets instructions obtained from a machine-accessible medium, such as a memory 156 or storage 158. In this example, the EHR module 100 includes one or more user interfaces, such as a user interface 160 to receive user inputs.

In the example of FIG. 2, patient data can be obtained in different formats, such as from different data storages, represented here by the patient database 162 having data from patients 164, which may be associated with different business organizational entities that may not be concerned about the compatibility of data formats or snaring of patient data between such business entities. In an example, the organizational entity providing the computer-assisted patient EHRs include, among other things, hospitals and health institutions (HHIs), Independent Practice Associations (IPAs), Preferred Provider Organizations (PPOs), Health Maintenance Organizations (HMOs), Practice Management Systems (PMS) companies, Electronic Medical Records (EMR) companies, Accountable Care Organizations (ACOs) and others.

Physician 168 data can also be obtained in different formats and from different data storages, which are represented here by a physician database 166. Example sources of physician data include medical practitioner databases, HHIs, ACOs, IPAs, PPOs, HMOs, PMSs, American Medical Association (AMA), various governmental agencies and others. In another example, the physician database 166 could also represent a proprietary collection of medical practitioner data which has been collected and filtered for use in clinical trial recruitment. The physician database 166 may also include physician data that is helpful in selecting physicians to serve as investigators for a clinical trial, such as number of patients, geographic location, and demographics of patients served. The auto load module 106, which may be a single auto load module or multiple auto load modules, such as the autoload modules 10 and 12, forwards the data to the security module 200. Because physician information may not be covered, under HIPAA regulations, the physician data may be forwarded to the physician database of the EDDB without removing identifying characteristics.

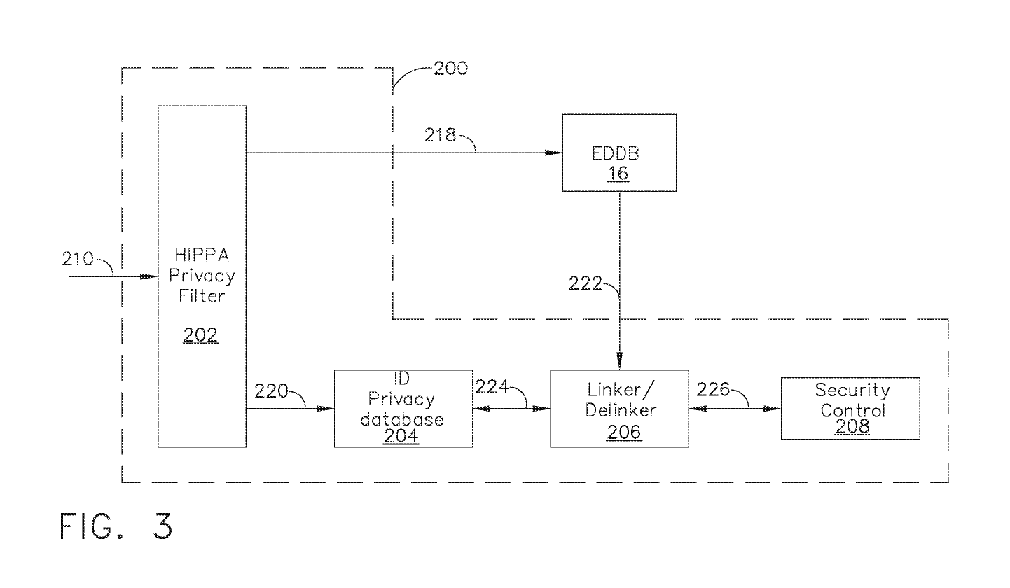

FIG. 3 shows one embodiment of the security module 200. The security module 200 anonymizes the EHRs by passing them through the HIPAA privacy fitter and thereby creates the anonyrnized EDDB database 16. In one embodiment, the ID privacy database 204 stores the correlation between the unique patient key and the patient identifying characteristics such as name, social security number, contact information, address, email address, phone number, twitter account, or other patient identifying characteristics. By storing the correlation between the unique patient key and the patient identifying characteristics, messages can be sent to the patient by identifying the patient by the unique patient key, sending the message through a linker/delinker 206 that links the unique patient key to the patient contact information, and then sending the message to the patient by wire or wireless electronic communication. Typically, this can be completed without human intervention, thus securing the privacy of the patient's data from any other individual, including the system operator.

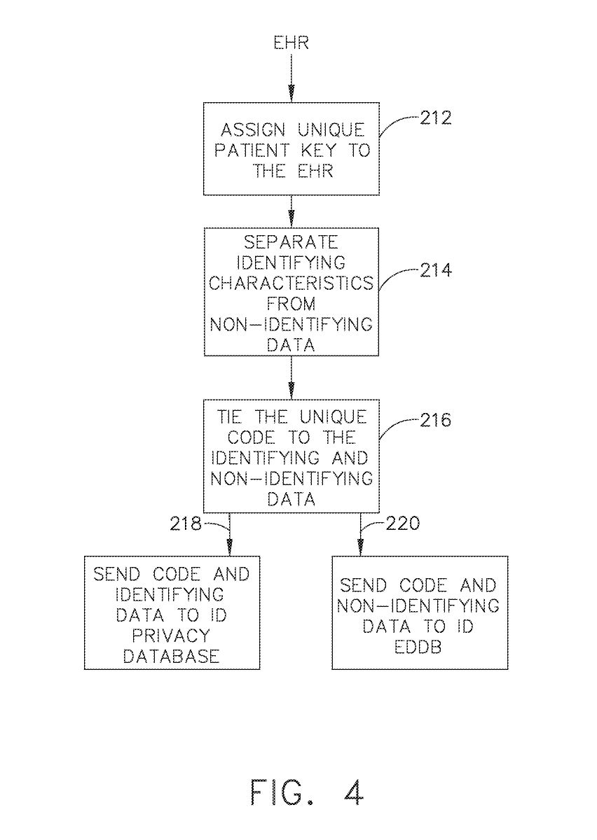

Information from the autoload module 10, 12, or 106 is fed to the HIPAA privacy filter as shown by arrow 210. As shown in FIG. 4, the HIPAA filter assigns a unique patient key to the EHR 212. The HIPAA filter then separates the identifying characteristics from the non-identifying data 214 and ties the unique patient key to each set of data 216. The code and identifying characteristics are then sent to the ID privacy database 204, as shown by arrow 220. The code and non-identifying data are sent to the EDDB database 16 as shown by arrow 218.

Referring back to FIG. 3, the linker/delinker 206 is controlled by security control 208 and communicates with the EDDB 16 as shown by arrow 222, with the ID privacy database 204 as shown by arrow 224, and with the security control 208 as shown by arrow 226. The linker/delinker 206 receives the non-identifying data with the unique patient key from the EDDB and accesses the privacy database 204 to re-identify the non-identifying data with the identifying characteristics in order to send a request to the individual associated with the data, as discussed later. Access to the linker/delinker 206 is restricted by the security control 208. The security control may be accessible only by an individual with an authorization code, or if may be completely machine controlled with no human intervention.

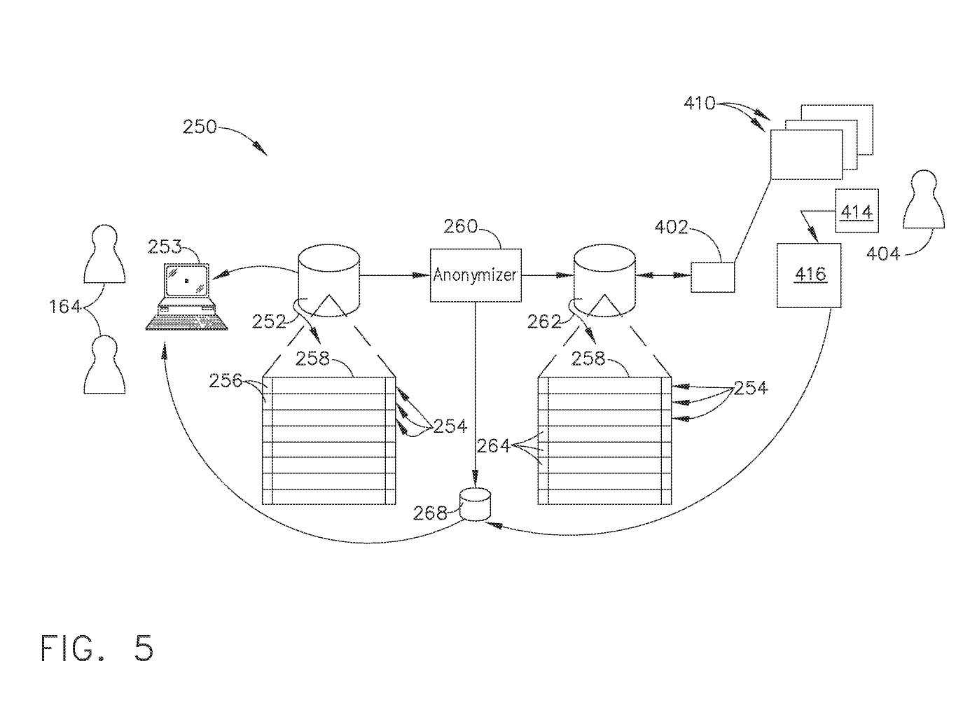

FIG. 5 shows another embodiment 250 of a method of anonymizing data utilizing a computer 253. The EHRs 252 will include many logical records 254 each associated with patient identification data 256 uniquely identifying a particular patient. The patient identification data 256 may, for example, be a number, an index value of the record, or a unique patient key 254 and is logically keyed to information allowing personal identification of the patient.

The data fields 258 of the EHRs 252 may include, for example, the patient's name, age, gender, as well as medical information such as height, weight, blood pressure, medical history, the results of lab tests, diagnoses by physicians, treatment outcomes, and the like. Included in the data fields 258 is information normally not freely available to the public and protected under federal standards such as HIPAA.

The data of the EHRs 252 may be received by an anonymizer 260 which copies the data from the EHRs 252, either on a periodic basis or as a “mirror” triggered by changes of the data of the EHRs 252, into an anonymized database 262. The anonymized database 262 also has records 254 with a one-to-one mapping with the records 254 of the EHRs 252. The difference between the anonymized database 262 and the EHRs 252 is that the patient identifying characteristics 256 are removed and replaced with a unique patient key 264 that can only be released with authorization of the patient.

The anonymized database 262 does not provide data that would allow personal identification of patients 164, In one embodiment, a separate one-way, cross-reference database 268 may be generated linking unique patient keys 264 to patient identification data 256 for use in reassociating the patient key to the patient identifying characteristics for communicating with the patient. With patient authorization, an authorized party, such as the patient's physician, a trial designer, or an investigator may be provided access.

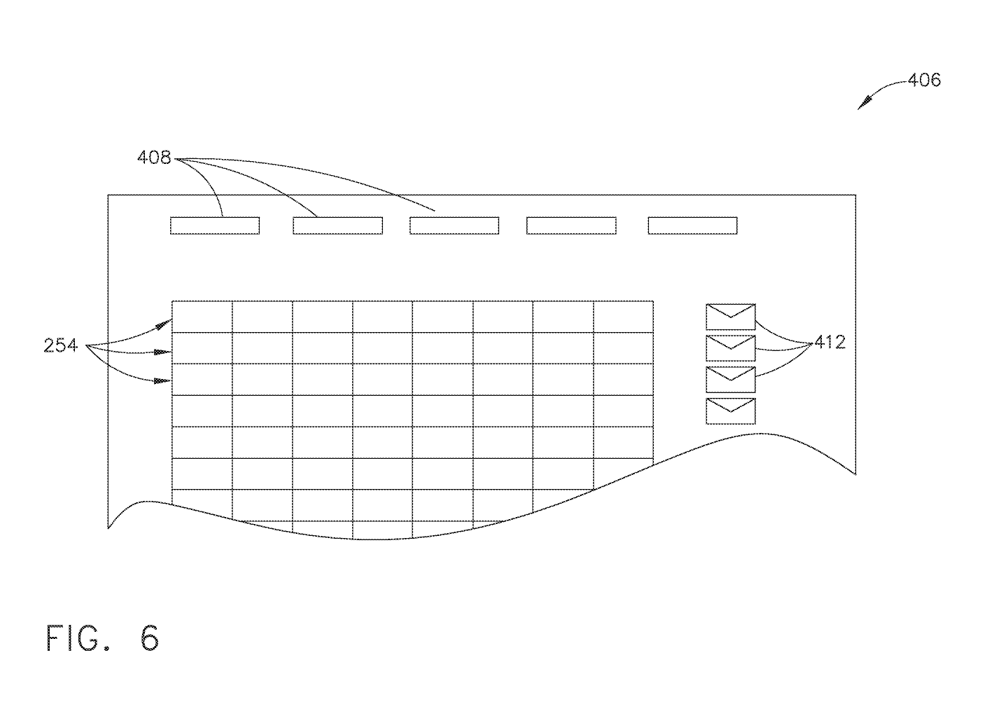

The database EDDB 16 and the patient source data provide an opportunity for clinical trial designers to obtain additional information from a large group of individuals. The server system 402 provides a clinical trial designer 404 with a search tool 410 that may be invoked. The search tool may be invoked via a search page 406, as shown in FIG. 6. Generally this search page 406 will provide search tools providing multifield search boxes 408 that may be linked in Boolean combinations. The revealed data records 254 may be exported to analysis programs or analyzed using charting and other statistical processing tools contained in the physician search tool 410. Each record 254 revealed in a search will be associated with a contact icon 412 allowing the clinical trial designer to contact the physician of the particular patient, or the patient directly, without knowing the patient's identity. Contact icon 412 employs a communication generator 414, such as an email, twitter, or text generator, and a communication service 416 that uses the cross reference database 268 or the linker/delinker 206 to identify the individual associated with the record 254 and provides an e-mail to a physician or the anonymous patient using an electronic communication such as email. This e-mail permits the clinical trial designers to contact the physician of a patient identified in the search, or to contact the patient directly, allowing the clinical trial designer to ask for more information about the patient in a physician-to-physician or researcher-to-patient exchange, such as through a survey or questionnaire. In this way the anonymity of patients 164 is preserved.

Referring back to FIG. 1, the community input module 300 allows members of the community, including researchers, investigators, physicians, patients, investigators, and other individuals to send data to the EDDB 16 through the HIPAA privacy filter. Typically, the ability to send data to the EDDB 16 is restricted to those with authorized access, either through an invitation to send data, an authorizing password, or in response to a survey. The data sent may include identifying characteristics such as name, address, and contact information and non-identifying information such as medical data. Other information may also be included.

In one embodiment, individuals at a community event, such as a health fair, may send data to the EDDB through the interactive community health events patient navigator 304. For example, individuals who are interested in participating in a clinical trial or assisting with the design of a clinical trial may choose to forward their data to the EDDB. The data sent may include identifying characteristics such as name, address, and contact information and non-identifying information such as medical data. Other information may also be included.

The community health event may be a traditional community health event or fair, such as those that provide information and free services to people in need. Or it may be a focused community health education program, held after a preliminary clinical trial has been designed, involving communities that have been identified by the clinical trial designers, possibly through the use of the EDDB data analysis. Consumers, advocates, and disease suffers are invited to the community events conducted with community physicians to receive information regarding the disease and the benefits and risks of clinical trials to raise awareness of the patients and others in the community. These events can provide an opportunity for community patient navigators to collect additional information for the EDDB. The focused health fairs also provide a venue for informing physicians with care-giving experience relating to the conditions that are the subject of the trial about the clinical trial process. These health fairs would typically include culturally appropriate materials to address known ethnic barriers to patient clinical trial involvement.

A physician may enter data into the EDDB through an interactive physician site assessment module 302. A physician may enter data for die purpose of being included in the pool of physicians that could be utilized in future clinical trials. The physician would typically enter the data necessary for a trial designer to determine whether the physician would be an appropriate candidate to serve as an investigator for a specific clinical trial. For example, the physician would enter identifying characteristics and information such as geographic location, patient population served, office hours, staff qualifications, and prior participation in clinical trials. Other information may also be included and entered.

Data may also be entered into the EDDB through the confidential survey responses module 306. The responses may be to surveys of patients, individuals, physicians, medical professions, or others initiated by a trial designer.

When data is entered through the community module, if is forwarded through an interactive online data input module 308 and then to the HIPAA filter. The security module, of which the HIPAA filter is a part, separates the identifying characteristics from the non-identifying data, as described previously. If the data input is from a survey response, the data will have either the survey responder's unique patient key or the responder's identifying characteristics associated with it, depending on whether the individual authorized the release of their identity. The survey response is then associated with other data for the same individual, typically by passing the response through the HIPAA privacy filter or the linker/delinker to associate the response with the unique patient key.

In cases where the clinical trial designer wishes to see additional or more detailed information about the person, such as an opportunity to review specific medical records or to analyze bio-samples, the prospective subject can be contacted through an interface and consent for decline to consent) to the release of such additional information. The clinical trial designer is informed through the system of such decision, and if permitted by such subject's action, provided the additional information. This contact could be made through an electronic communication sent through the linker/delinker 206. The system makes it possible, if the patient desires, for the patient's identity to remain undisclosed to the clinical trial designer in the event the patient wishes to do so. Similarly, if the clinical trial designer desires to contact an anonymous potential subject, the individual can be contacted through the linker/delinker 206, and is provided an opportunity to consent (or decline to consent) to such contact.

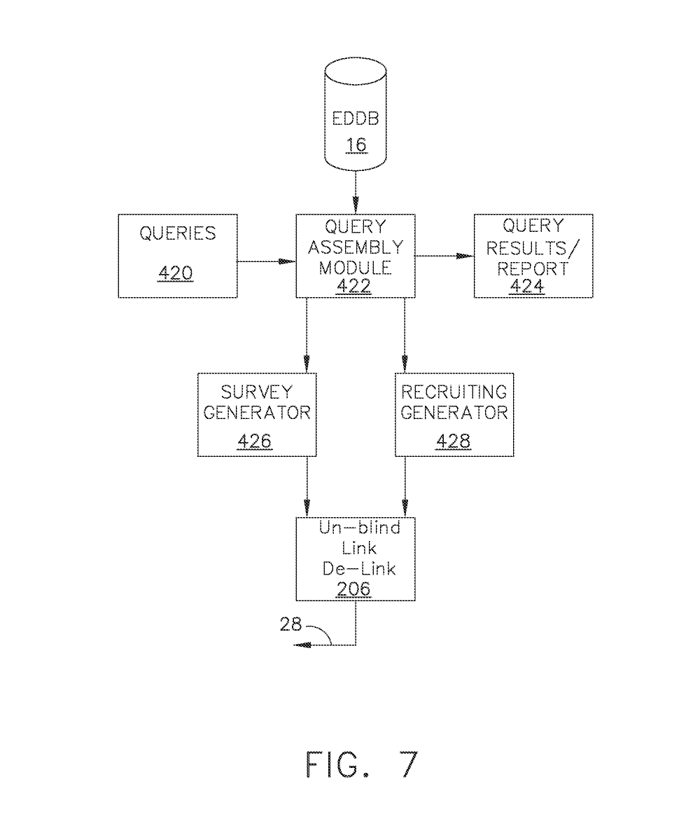

FIG. 7 shows a flowchart of the analysis a clinical trial designer may conduct using the EDDB database 16. As discussed, the EDDB database 16 contains anonymized medical records. Using a search tool, the clinical trial designer may generate queries 420 to search for key information in the medical records. The designer may include search parameters such as gender, age, race, therapies, diagnoses or suspected illnesses, diseases, or conditions, congenital anomalies, ethnicity, geographic origin, current location, physical injuries, past surgeries, metabolic injury, induction or inhibition, nutritional or dietary status, nutritional or dietary exposure, genetic profile, health status, attitude towards disease, attitude toward medical treatment, attitude toward healthcare provider, smoking history, alcohol intake history, recreational drug use, use of herbal, alternative, or natural medicine, exposure to herbal, alternative, or natural medicine, environmental toxin exposure, and generalized or localized ionizing radiation exposure. As an example, the clinical trial designer may be interested in assessing the possibility of conducting a clinical trial for a diabetic drug. His target group of subjects is females, ages 40 to 60 that are obese and have had diabetes for over 10 years. The clinical trial designer enters those limitations into the search page 406 (FIG. 6), which forwards it to the QAM 422. The QAM 422 searches the EDDB and provides a listing of those individuals, identified by unique patient key, meeting the search criteria. This listing is known as a target group. The clinical trial designer may cluster those individuals by further analysis, such are geographic areas in which they live. The clinical trial designer may generate a report 424 showing the selected individuals identified by the unique patient key.

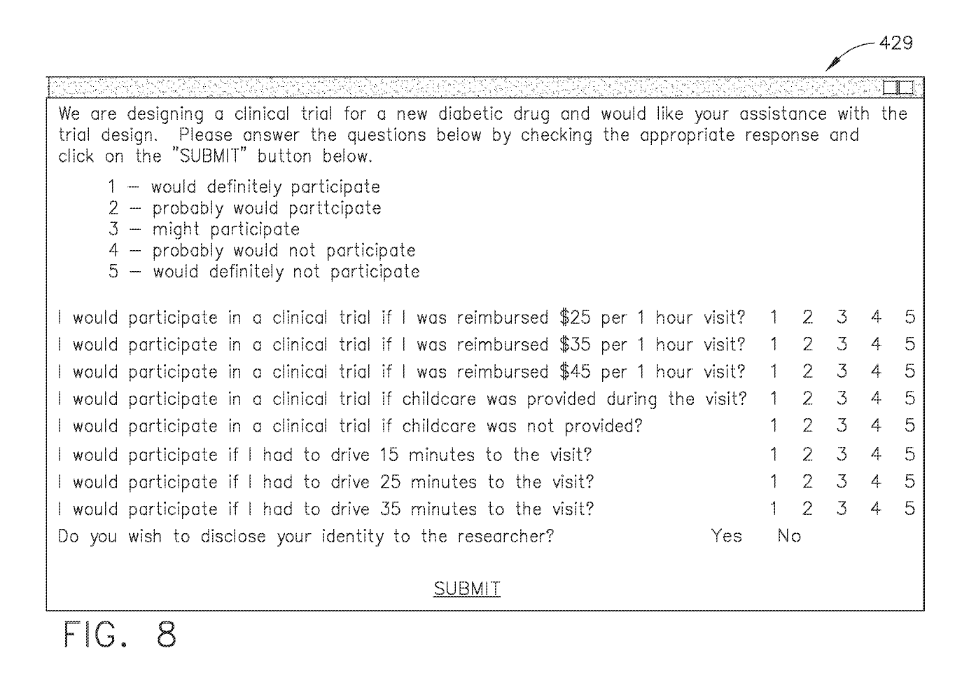

To design a clinical trial for maximum subject participation, the trial designer may desire to have certain questions answered by a representative group similar in demographics to those who would be subjects in a clinical trial in order to optimize the trial design, for example, the trial designer may be interested in identifying barriers to clinical trial participation, such as driving distance, compensation requirements, best times for conducting the trial, and trial duration. Using the survey generator 426, the clinical trial designer would generate a survey. One example of a survey is that asks questions that a trial designer may find relevant to designing a clinical trial is shown in FIG. 8. The clinical trial designer would then use the survey responses to design a trial that minimizes barriers to participation in the clinical trial. Alternatively, responses to the survey may be used to further define a target group. The further defined target group may then be resurveyed. Additionally, information about individuals interested in participating in a clinical trial is stored in the patient recruitment resources 34. This information can be accessed and utilized in the future when recruiting potential trial subjects.

The surveys provide another avenue of engaging and educating the community about clinical trials. The survey can provide the trial designers insight on the practicality, barriers to participation, acceptability, and cultural appropriateness of the trial design. The survey process provides information to the trial designers early in the design process so that the trial can be designed to minimize the impact of barriers identified in the surveys. Thus, designing the trials using the survey results can increase patient acceptance of the trial minimize delays, decrease lack of patient availability due to protocol design and stringent inclusion and exclusion criteria, and avoid protocol deviations and violations.

In addition to surveys, the survey generator can be use for commercial activities. For example, the survey generator could be used to generate advertisements for products such as pharmaceuticals or medical devices, rebates forms for products, or other commercial activities that may or may not generate revenue.

Once generated, the survey is tied to the unique patient key and forwarded to the linker/delinker 206. The linker/delinker associates the unique patient key with the identifying characteristics, which includes electronic means of contacting the individual, and sends an electronic message with the survey to the individual as shown by arrow 28. FIG. 1. To enhance response rate and response time, the clinical trial designer may offer compensation to individuals who complete the survey. For example, the clinical trial designer may offer compensation in the form of cash, a gift certificate, or other payment for the first 500 individuals who respond to the survey.

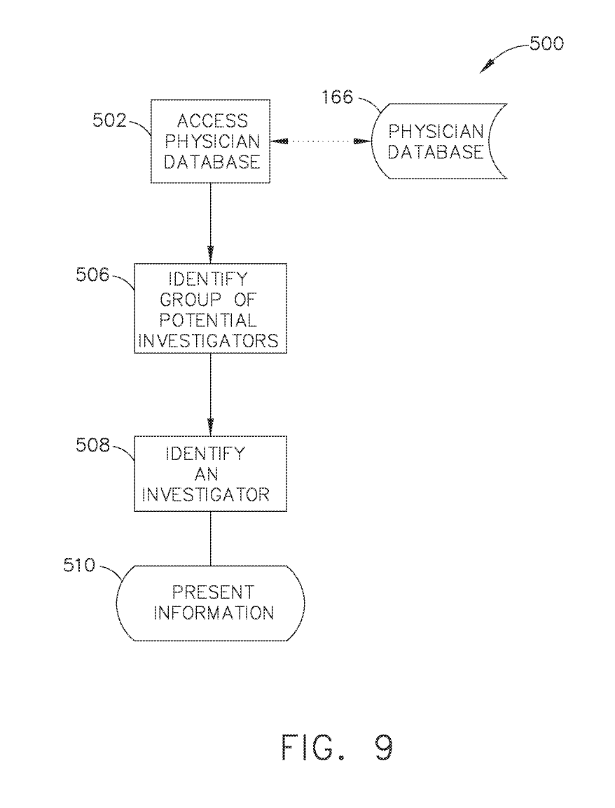

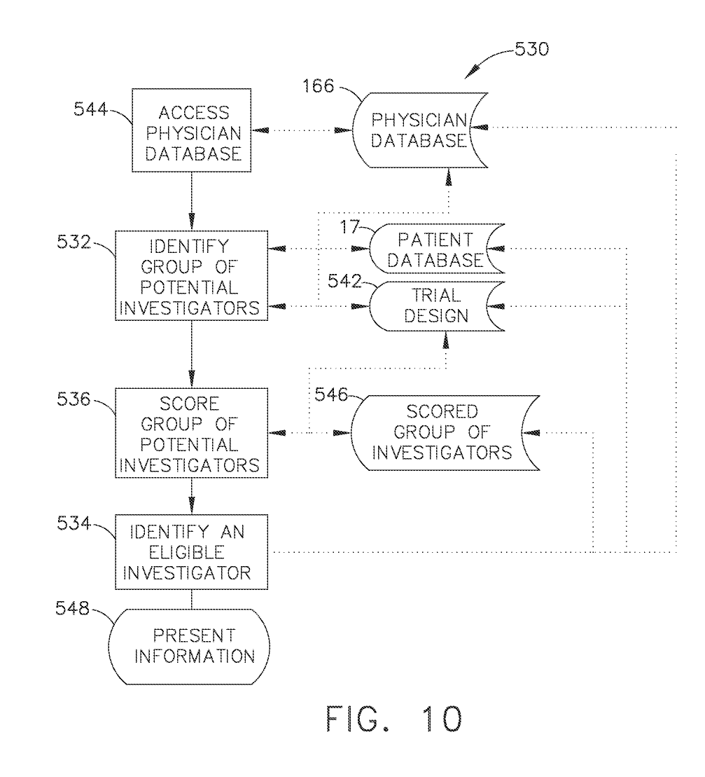

Another factor in a successful clinical trial is the selection and recruitment of the right investigator for a particular clinical trial site. Once the clinical trial designer has designed a clinical trial based on input from potential trial participants, the clinical trial designer can then conduct an investigator search. FIG. 9 illustrates an example method for selecting an investigator (physician) for a particular clinical trial out of a pool of potential candidates. FIG. 10 illustrates another example of investigator selection incorporating information about patients eligible for the particular clinical trial into the selection process.

The process 500 of selecting an investigator begins by accessing a physician database at 502. The physician database may be separate from the physician database of the EDDB, such as database 166 of FIG. 2, or it may be the EDDB physician database 19 of the EDDB 16. In this example, the physician database 166 is accessed at 502. At 506 the process 500 identifies a group of potential investigators from the physician database. Identification may include searching for a particular specialty, limiting the geographic scope of search, or any other sponsor-defined criteria that can assist in narrowing the field of potential candidates to be investigators in a clinical trial. Identification can also include a filtering mechanism. For example, utilizing the Food and Drug Administration's (FDA's) blacklist, physicians who are ineligible to participate in clinical trials can be filtered out. In another example, the group of potential investigators consists of only those physicians who have eligible patients for the study or only those physicians who have a required piece of equipment in their office.

Once the universe of available physicians is narrowed to a group of potential investigators at 506, the process 500 can identity a suitable investigator at 508. This second identification takes one or more clinical trial sponsor-defined criteria into account in selecting an investigator from the group of potential investigators. Once the investigator is selected at 508, the process 500 moves to 510 where information regarding the selection process 500 is presented to the clinical trial designer. In an example, the presented information includes both the identified investigator and the group of potential investigators identified at 506. In another example, only the one or more identified investigators and associated data is displayed or reported to the clinical trial designer. In another example, associated data includes sponsor-defined criteria used to select the investigator. And, in another example, associated data includes information about the investigator such as specialty, clinic location, available office equipment, and patient statistics.

FIG. 10 illustrates another example of a method for identifying an investigator that includes accessing a physician database 166 and a patient database 17 and utilizes the trial design 542 to selectively identify the investigator. The method 530 includes procedures for identification of a group of potential investigators 532, identification of an eligible investigator 534, as well as scoring a group of potential investigators 536. The information from a patient database 17 and trial design 542 can be used at any or all of these points in the process. In another example, accessing die patient database includes a scoring or clustering mechanism operating on the patient data. Once scored or clustered, the analyzed patient data could be utilized to assist in the investigator selection process 534. For example, the group of potential investigators identified at 532 could be identified based on proximity to clusters (or a particular cluster) of eligible patients identified from the patient database 17.

The process 530 in FIG. 10 starts by accessing a physician database at 544. In an example, physician database 166 is accessed at 544. The physician database may be separate from the physician database of the EDDB, such as database 166 of FIG. 2, or it may be the EDDB physician database 19 of the EDDB 16. The process 530 continues by identifying a group of potential investigators at 532. In an example, identifying includes a filtering mechanism. For example, physicians are filtered based on specialty to identify the group of potential investigators 532. Then the group of potential investigators can be scored 536 based on various factors including physician characteristics, patient demographics, or sponsor-defined criteria found in the trial, design database 542 for the targeted clinical trial to produce a group of scored investigators 546. In an alternative example, the scoring 536 is done on the entire universe of physicians. In this example identifying a group of potential investigators 532 returns all physicians in the physician database.

Once a group of scored investigators 546 is determined, the process moves to identifying at least one eligible investigator 534. The at least one eligible investigator is identified utilizing sponsor-defined criteria for the targeted clinical trial. The sponsor-defined criteria are compared or analyzed against information including the investigator scores, eligible patent data and other relevant physician characteristics. The information is then presented 548 to the clinical trial designer.

An exemplar investigator selection that follows the process 530 depicted by FIG. 10 utilizes a physician specialty to identify a group of potential investigators and then scores the physicians on proximity to eligible patient clusters and propensity to administer a particular procedure tor treatments similar to the targeted clinical trial. Limiting the group of potential investigators to only those physicians who are board certified to conduct the targeted specialty reduces the amount of processing necessary to produce likely physician candidates.

In an example, the scoring process 536 may be weighted equally towards eligible patient clusters and propensity for a particular procedure. However, for some clinical studies, proximity to patients might be more important. The system allows for the sponsor to select weighting factors on any criteria used in the scoring or identification processes. This multi-dimensional scoring process allows the system to pinpoint investigators with the targeted combination of attributes tor the clinical trial.

The selection of clinical trial sites that utilize information including physician, patient and geographic data together with sponsor-defined criteria for the targeted clinical study to select suitable locations to conduct the study may also be included.

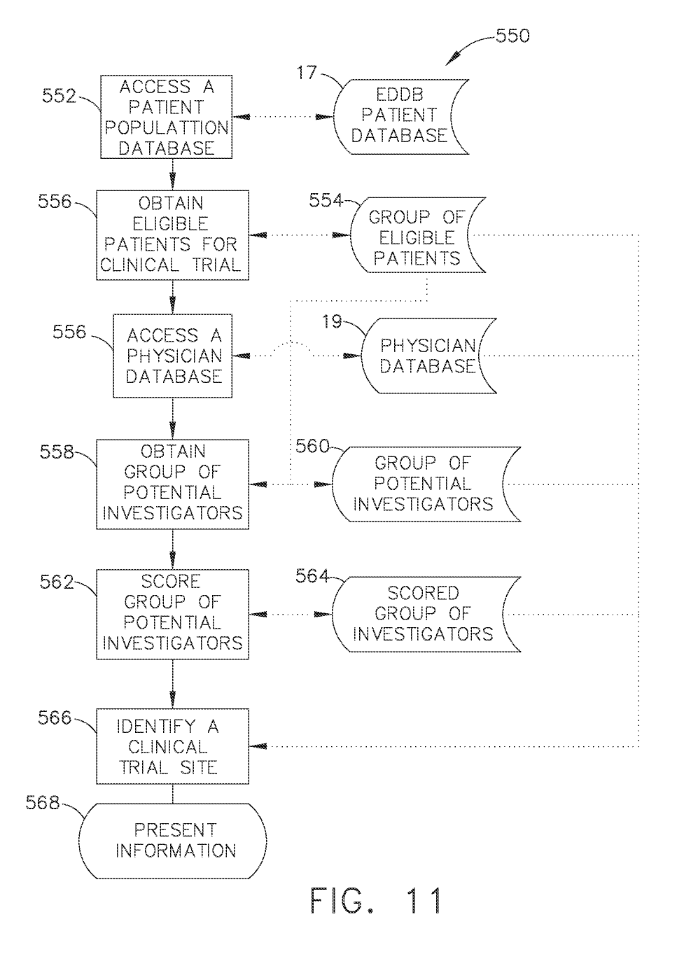

FIG. 11 illustrates a process 550 for identifying at least one clinical trial site. The process begins at 552 by accessing a patient database 17 of the EDDB database. From the patient, database a group of eligible patients 554 is obtained at 556. In an example, obtaining the group of eligible patients 554 includes a filtering mechanism. For example, eligible patients can be obtained by filtering the patient database based on a sponsor-define criteria or other criteria used in designing the trial based on the survey responses. Criteria could include gender, age, race, therapies, diagnoses or suspected diseases, illnesses or conditions, congenital anomalies, ethnicity, geographic origin, current location, physical injuries, past surgeries, metabolic injury, induction or inhibition, nutritional or dietary status, nutritional or dietary exposure, genetic profile, health status, attitude towards disease, attitude toward medical treatment, attitude toward healthcare provider, smoking history, alcohol intake history, recreational drug use, use of herbal, alternative, or natural medicine, exposure to herbal, alternative, or natural medicine, environmental toxin exposure, generalized or localized ionizing radiation exposure and other health related data. Next the system accesses an EDDB physician database 19 at 556. Alternatively, the trial design system may access a physician database 166, or it may access both.

At 558, the system utilizes information including the group of eligible patients 554 and the physician database 19 to obtain a group of potential investigators 560. In an example, obtaining the group of potential investigators 558 could include clustering the group of eligible patients into geographic locations and filtering physicians based on a sponsor-defined proximity from eligible patient clusters. In an alternative example, obtaining the group of potential investigators 558 can include filtering physicians based on a sponsor-defined physician characteristic required for the clinical trial. In another example, obtaining the group of potential investigators utilizes a combination of criteria focused on either patients or the physicians required for a clinical trial. Like other procedures which limit the universe of potential physicians or patients, a scoring and thresholding process can also be utilized. For example, a physician could be scored based on her number of patients eligible for the clinical study and then a threshold score can be applied to eliminate physicians without sufficient eligible patient access.

After a group of potential investigators 560 is obtained, the process 550 continues by scoring the group of potential investigators at 562 to produce a group of scored investigators 564. Scoring of potential investigators can be done based on physician specific characteristics including proximity to eligible patients or patient clusters, physician qualifications or experience, preference tor a particular procedure, familiarity with culture/ethnicity, languages spoken by physician/staff, office equipment, office staff profile, referral patterns, even proximity to public transportation systems, or other criteria.

Once the potential investigators are scored at 562, the process 550 moves to identify a clinical trial site at 566. In an example, the identification 566 can utilize inputs from the scored group of investigators 560, the group of potential investigators 564, the physician database 19, or the group of eligible patients in identifying a clinical trial site. Identification at 566 can include operations such as clustering or scoring on the input data. In an example, identifying a clinical trial site can include clustering the eligible patients, scoring the group of potential investigators based on proximity to patient clusters and office staff profile. The identification at 566 can select clinical sites that include a substantial number of potential investigators within a sponsor-defined proximity to the patient clusters and having the required staff profile.

The clinical trial site selection process depicted in FIG. 11 can conclude by presenting information regarding the identified clinical trial site to the clinical trial designer at 568. In an alternative example, the process can conclude by presenting a series of clinical trial sites that meet the sponsor-define clinical trial criteria. In either case the system is capable of including detailed patient, physician and general demographic information regarding the identified site. In an example where multiple sites are identified the system allows for the user to select from the identified site for reporting purposes.

Referring back to FIG. 1, an example of a clinical trial design and subject and physician selection will now be described. EHRs from the community are loaded into the EDDB through the physician EHR connection 6 and the hospital EHR connection 8, the autoload modules 10 and 12 and the HIPAA privacy filter to remove identifying characteristics from the data. The data may be updated on a periodic basis, either defined by a predetermined duration after which the EHR data is updated or by an automatic or manual search feature which searches for changes in the data and updates the EDDB when new data is found.

The EDDB is also loaded with data from a community health events navigator 304. Because a survey has not yet beers conducted and a draft clinical trial design has not been complete, the data uploaded at this time would be of a more generic variety obtained at a traditional health fair. The EDDB is also loaded with physician information, such as demographics and populations served and. geographic location.

The trial designer then prepares a query using a search engine to search the EDDB for individuals meeting certain criteria, the criteria based, on the proposed target of the clinical trial drug. For example, if the clinical trial drug is to treat diabetes primarily in females ages 30 to 50, then the trial designer would narrow the potential subject group to individuals meeting those criteria, otherwise known as members of a target group. The trial designer may choose to further narrow the group to those living in major metropolitan areas to facilitate the clinical trial.

The trial designer can then prepare a survey similar to that in FIG. 8 to identify potential barriers to members of the target group participating in a clinical trial. Responses to the survey are received and collected by the survey receiver 306 and allow the trial designer to design a trial to maximize subject participation and to minimize barriers to participation. To encourage rapid response to the survey, the trial designer may compensate members for responding to the surveys. As one skilled in the art may observe, the EDDB database and the ability to receive rapid responses to a survey enable a trial designer to test various options for a trial design and optimize a trial design quickly.

After designing the trial based in part on the survey results, the trial designer can use the system to recruit trial subjects, identify geographic locations to hold clinical trials, and identify physicians to serve as investigators. Here, the trial designer has selected previous major metropolitan areas as the geographic area in which to conduct the trial. Using the EDDB that also includes data on physicians, the trial designer can then identify physicians in those geographic areas who meet certain qualifications to serve as investigators. These criteria may include, in addition to geographic areas, patient populations served, prior experience in clinical trials, and other criteria as previously described. Using the same mechanism as the survey module described above, the trial designer may then send a communication to the identified physicians to request their participation in the drug trial.

The trial designer may then send a communication to patients to request their participation in the clinical trial with the query 420, QAM 422, and recruitment generator 427 shown in FIG. 7. Additionally, the patient recruitment resource 34 is a database which stores information on individuals or members of a target group who have expressed interest in participating in clinical trials, may be used, as a source for potential subjects. Typically, the trial design and protocol must be reviewed and approved by an IRB before the subjects may be solicited for participation in a clinical trial. This request to participate in a clinical trial may be sent in the same manner the survey is sent to the individuals. As before, the trial designer may encourage a quick response by compensating the individuals for rapid responses. The trial designer may select investigators based on the method shown in FIG. 10 or may select investigators and clinical trial sites based on the methods shown in FIG. 11.

After designing the clinical trial to maximize patient participation, having an IRB review and approve the clinical trial protocol, and recruiting trial subjects, the clinical trial may proceed in the traditional manner.

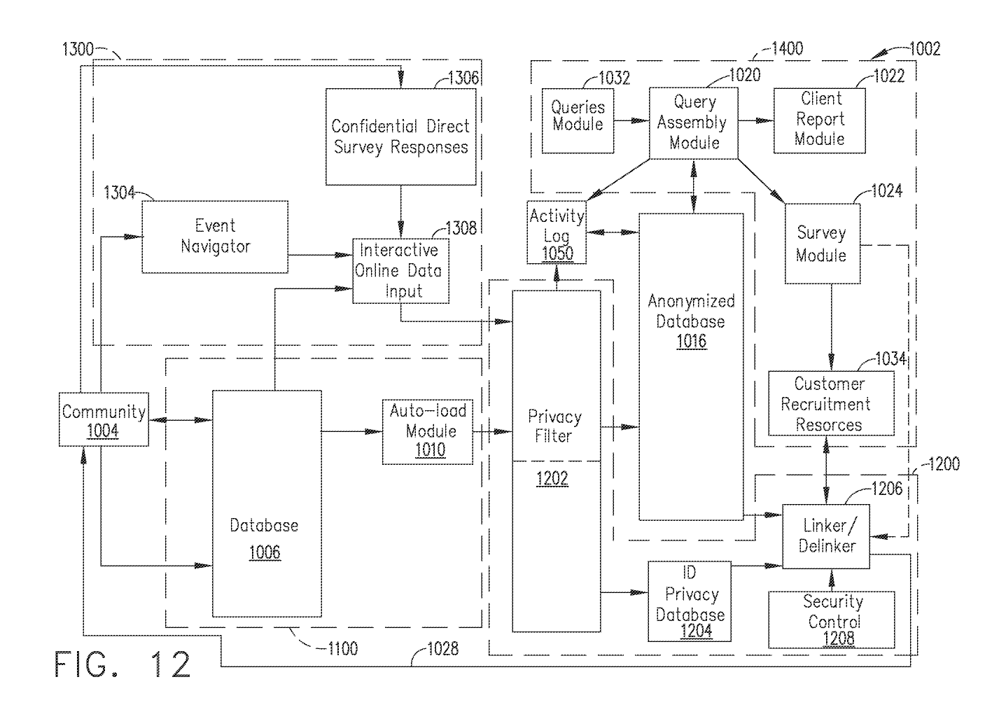

In another embodiment shown in FIG. 12, a community 1004 includes members of the general community (which may also be referred to as a general population), made up of individuals who may also be considered customers or consumers. Typically, during visits to a bricks and mortar store, online retailer, bank, or other retail institution, an individual who makes a transaction has data related to their activities, such as types of products purchased, time of purchase, transaction activity, or other personal habits, stored in a database, the database thereby containing individual consumer data. The information may be coded to link with the particular individual, particularly if the individual uses a loyalty card, identifying credit card, or enters his or her personal information, If identifying information is not available, other information, such as that obtained through a cashier or a computer identification program such as a “cookie”, may be used to identify the individual, albeit not necessarily by name. As shown in the database module 1100, this data for individuals stored can be stored in a database 1006. Auto-load module 1010 loads a plurality individual consumer data from the database 1006 to privacy filter 1202 that de-identifies the data by removing identifying features such as name, address, email addresses and other identifying characteristics and assigns a unique customer key to the data, resulting in de-identified individual consumer data.

The security module 1200 includes the privacy filter 1202, an ID privacy database 1204, security control 1208, and a linker/delinker 1206. Alternatively, the ID privacy database 1204, security control 1208, and the linker/delinker 1206 may be incorporated in the privacy filter 1202. In operation the autoload modules 1010 passes the data through the privacy filter, which anonymizes the data by removing identifying characteristics, assigns a unique customer key to the data, and forwards the data to a de-identified or anonymized database 1016. The privacy filter 1202 also loads a unique customer key associated with each individual to an ID privacy database 1204 that is part of the security module 1200. The ID privacy database 1204 stores and maintains the confidentiality of the unique customer key associated with each individual record for the purpose of re-identifying the individual if and when future contact with an individual associated with a unique customer key is desired.

An analysis and questioning module 1400 includes a Query Assembly Module (QAM) 1020, a client report module 1022, a surveying module 1024, a queries module 1032, and a consumer recruitment resource 1034. Various queries can be drafted in the query module 1032 and presented to the anonymized database through the QAM 1020. In one example, a researcher can submit a query to the QAM for all individuals making a specific purchase, such as paper towels. While this example addresses consumers purchasing paper towels, it is also applicable to individuals with many other purchasing, browsing, or transaction habits. The QAM then searches and retrieves from the anonymized database a list of individuals identified by the unique customer keys who purchase paper towels and non-identifying data for those individuals. The individuals who meet the query criteria are members of what is known as a target group. The QAM can then output a client report 1022 listing those individuals. Other outputs could include only the number of individuals meeting the query limitations.

Once defining a target group, a researcher may create a survey in the survey module 1024 for members of the target group. The researcher drafts the survey and selects the individuals, identified by their unique customer key, who are members of the target group to whom the survey should be sent. The survey can be sent to the entire target group or only to certain members in the target group. The survey is sent through the linker/delinker 1206 which links the unique customer key with the member, and sends the survey by way of an electronic communication or transmission 1028 to the member of the target group. The electronic transmission 1028 may be wired, such as through the internet, or it may be wireless, such as to a smart phone, or both.

As shown in FIG. 12, an activity log 1050 may also be included for logging transactions performed by the privacy filter, autoload modules, interactive data input, QAM module, and any other modules that are or may be a part of the system. The activity log 1050 therefore provides a means of auditing substantially all the activity of the system 1002.

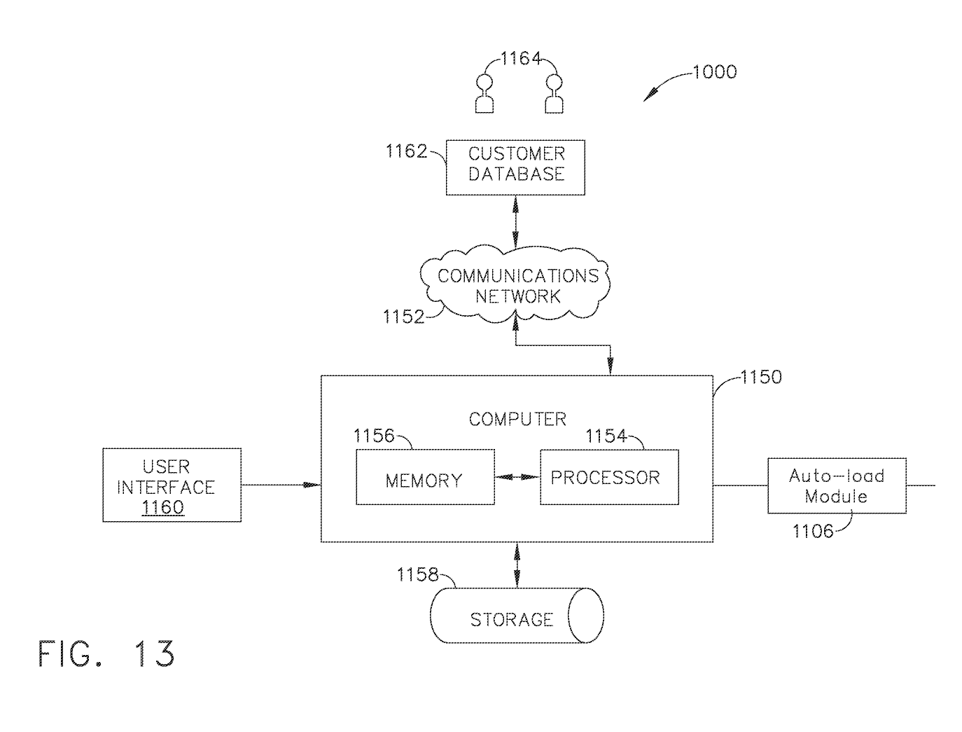

FIG. 13 is a block diagram of one example of a module 1000 for computerized loading of consumer information into the anonymized database. FIG. 13 also includes computer architecture and a computer 1150 coupled to a communications network 1152, such as the Internet or wired connection. In this example, the computer 1150 includes a processor 1154 that executes or interprets instructions obtained from a machine-accessible medium, such as a memory 1156 or storage 1158. In this example, the module 1100 includes one or more user interfaces, such as a user interface 1160 to receive user inputs.

In the example of FIG. 13, consumer information can be obtained in various formats from different data storages, represented here by the customer database 1162 having data from consumers 1164, which may be stored in databases by a plurality of organizational entities that may not be concerned about the compatibility of data formats or sharing of data between or among other entities. In an example, the organizational entity providing the consumer information include, among others, non-profits, online and retail stores, pharmacies, grocery stores, banks, government institutions and any other organization that gathers data about its clients, consumers or individuals utilizing its goods or services. The auto load module 1106 forwards the data to the security module 1200.

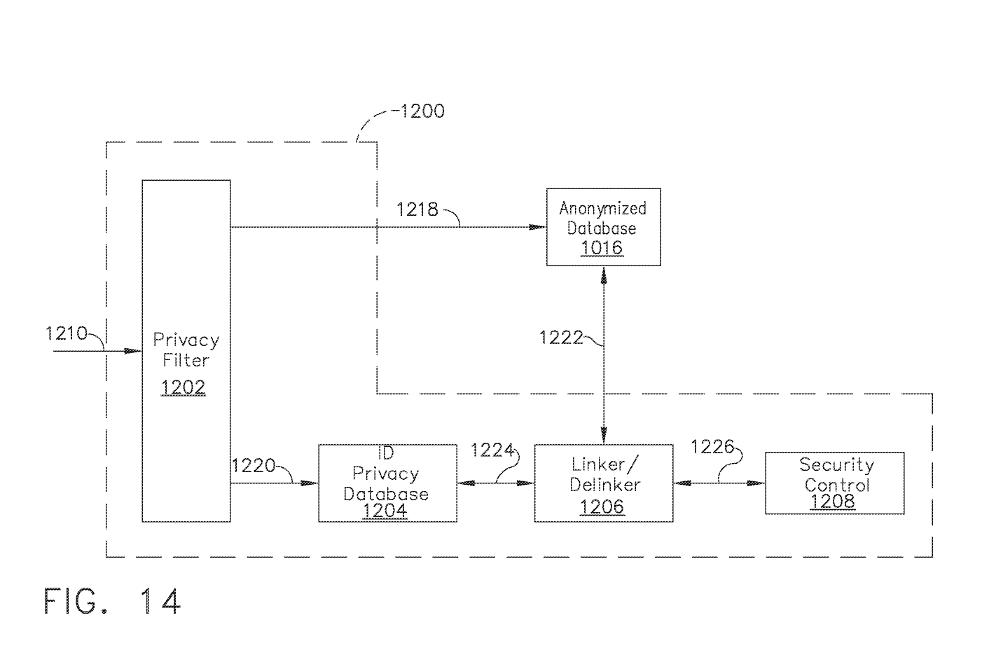

FIG. 14 shows one embodiment of the security module 1200. The security module 1200 anonymizes the consumer information by passing it through the privacy filter and thereby creates the anonymized database 1016. In one embodiment, the ID privacy database 1204 stores the correlation between the unique customer key and the individual identifying characteristics, which may include social security number, contact information, address, email address, phone number, twitter account, or other identifying characteristics. By storing the correlation between the unique customer key and the individual identifying characteristics, messages can be sent to the customer by identifying the customer by the unique customer key, forwarding the message through a linker/delinker 1206 that links the unique customer key to the customer contact information, and then sending the message to the customer by wire or wireless electronic communication. Typically, this can be completed without human intervention, thus securing the privacy of the customer's data from any other individual, including the system operator.

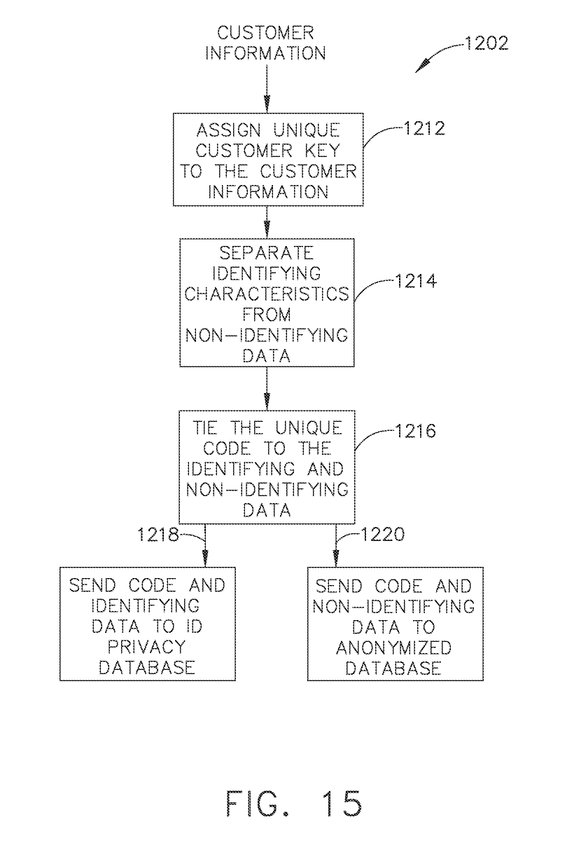

Information from the autoload module is fed to the privacy filter 1202 as shown by arrow 1210. As shown in FIG. 15, the privacy filter assigns a unique customer key to the individual information 1212. The privacy filter then separates the identifying characteristics from the non-identifying data 1214 and ties the unique customer key to each set of individual consumer data 1216. The code and identifying characteristics are then sent to the ID privacy database 1204, as shown by arrow 1220. The code and non-identifying data are sent to the database 1016 as shown by arrow 1218.

Referring back to FIG. 14, the linker/delinker 1206 is controlled by security control 1208 and communicates with the anonymized database 1016 as shown by arrow 1222, with the ID privacy database 1204 as shown by arrow 1224, and with the security control 1208 as shown by arrow 1226. The linker/delinker 1206 receives the non-identifying data with the unique customer key from the anonymized database and accesses the privacy database 1204 to re-identify the non-identifying data with the identifying characteristics in order to send a request to the individual associated with the data, as discussed later. Access to the linker/delinker 1206 is restricted by the security control 1208. The security control may be accessible only by an individual with an authorization code, or it may be completely machine controlled with no human intervention.

The method of anonymizing data shown in FIG. 5 for EHRs may also be used for consumer data. Additionally, the search page shown in FIG. 6 may also be used for searching consumer data records.

Referring back to FIG. 12, an input module 1300 allows members of the community, including researchers, focus groups, and other individuals to send data to the anonymized database 1016 through the privacy filter 1202. Typically, the ability to send data to the anonymized database 1016 is restricted to those with authorized access, either through an invitation to send data, an authorizing password, or in response to a survey. The data sent may include identifying characteristics such as name, address, and contact information and may include non-identifying information such as customer data. Other information may also be included.

In one embodiment, individuals at an event, such as a foots group, may send data to the anonymized database through the event navigator 1304. The event may be any one of a number of events searching to educate or obtain individual information. For example, it may be a focus group of individuals with specific buying habits. Individuals who are interested in participating in a focus group or future focus groups may choose to forward their data to the anonymized database. The data sent may include identifying characteristics such as name, address, and contact in formation and non-identifying information such as customer data. Other information may also be included.

Data may also be entered into the anonymized database through the confidential survey responses module 1306. The responses may be to surveys of consumers, clients, individuals or others initiated by a researcher.

When data is entered through the input module 1300, if is forwarded through an interactive online data input module 1308 and then to the privacy filter. The security module, of which the privacy filter is a part, separates the identifying characteristics from the non-identifying data, as described previously. If the data input is from a survey response, the data will have either the survey responders unique customer key or the responders identifying characteristics associated with it, depending on whether the individual authorized the release of then identity. The survey response is then associated with other data for the same individual, typically by passing the response through the privacy filter or the linker/delinker to associate the response with, the unique customer key.

In cases where the researcher wishes to see additional or more detailed information about the person, such as an opportunity to review specific individual information, the customer can be contacted through an interface and consent (or decline to consent) to the release of such additional information. The researcher is informed through the system of such decision, and if permitted by the customer's action, provided the additional information. This contact could be made through an electronic communication sent through the linker/delinker 1206. The system makes it possible, if the customer desires, for the customer's identity to remain undisclosed to the researcher in the event the customer wishes to do so.

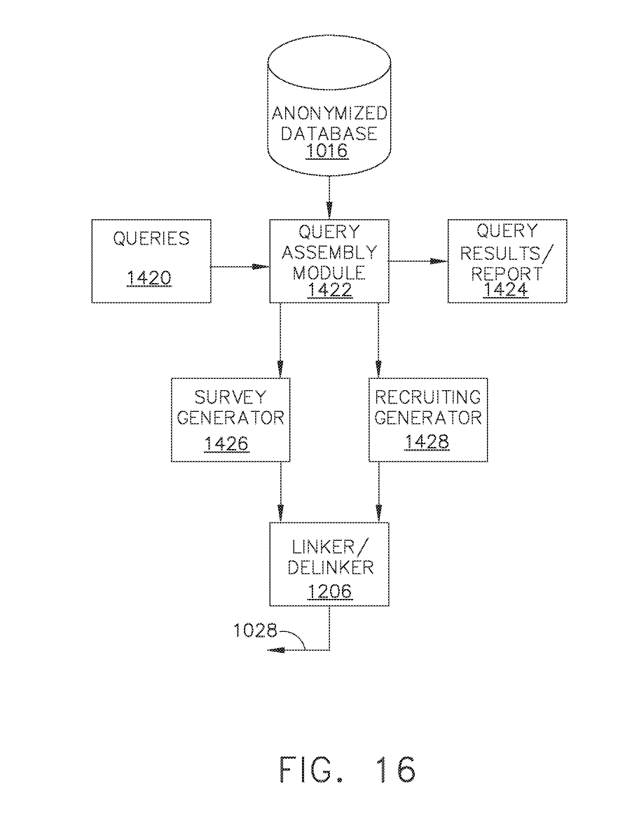

FIG. 16 shows a flowchart of the analysis a researcher may conduct using the anonymized database 1016 which contains anonymized individual information or data. Using a search tool, the researcher may generate queries 1420 to search for key information in the anonymized database. The researcher may include search parameters such as gender, age, race, income level, purchasing, browsing, travel, banking, investing, work, television or any other activities or habits engaged in by the customer. As an example, a researcher may be interested in conducting a focus group of mutual bind buyers. His target group of subjects is females, ages 30 to 50 that invest over $10,000 a year in mutual funds. The researcher enters those limitations into a search page similar to that shown in FIG. 6, which forwards it to the QAM 1422. The QAM 1422 searches the anonymized database and provides a listing of those individuals, identified by unique customer key, meeting the search criteria. This listing is known as a target group. The researcher may cluster those individuals by further analysis, such are geographic areas in which they live. The researcher may generate a report 1424 showing the selected individuals identified by the unique customer key.

Additionally, a researcher may use the system to assist with designing a customer loyalty program. The researcher may desire to have certain questions answered by a representative group similar in demographics to those who would be targets for the customer loyalty program. For example, the researcher may be interested in identifying barriers to participation such as difficulty in redeeming rewards, reward amounts, and duration of awards before expiration Using the survey generator 1426, the researcher would generate a survey. The researcher would then use the survey responses to design a program that minimizes barriers to participation. Alternatively, responses to the survey may be used to further define a target group. The further defined target group may then be resurveyed. Alternatively, the researcher may use a recruiting generator 1428 to request individuals to participate in a focus group on products, coupons, loyalty programs, or other consumer needs or programs, or the researcher may request members of the target group to participate in a focus group based on their survey responses.

As in the embodiment for clinical trial designs described earlier, the survey can provide a researcher in sight on the practicality, barriers to participation, acceptability, and cultural appropriateness of a consumer program, product or other consumer offering, the researcher may conduct a focus group based on the survey responses.

Once generated, the survey is tied to the unique customer key and forwarded to the linker/delinker 1206. The linker/delinkerr associates the unique customer key with the identifying characteristics, which includes electronic means of contacting the individual, and sends an electronic message with the survey to the individual as shown by arrow 1028. FIGS. 12, 16. To enhance response rate and response time, the researcher may offer compensation to individuals who complete the survey. For example, the researcher may offer compensation in the form of cash, a gift certificate, or other payment for the first 500 individuals who respond to the survey.

While the present invention has been illustrated by the description of embodiments thereof, and while the embodiments have been described in considerable detail, it is not intended to restrict or in any way limit the scope of the appended claims to such detail. Additional advantages and modifications will be readily apparent to those skilled in the art. The invention is therefore not limited to the specific details, representative apparatus and method, and illustrated examples shown and described. Accordingly, departures may be made from such details without departing from the scope or spirit of the invention.

What is claimed is:

1. A method of collecting input from individuals comprising:
a) searching a database containing a plurality of individual consumer data,
b) assigning a unique customer key to each individual consumer's data and removing the individual's identifying characteristics from the individual consumer's data with a computer having a memory and a processor operating a privacy filter to provide de-identified individual consumer data,
c) maintaining a confidential record of each individual's identifying characteristics associated with the unique customer key,
d) analyzing the de-identified individual consumer data to define members of a target group,
e) passing an electronic communication including a survey through a linker/delinker to link contact information associated with the unique customer key of a member of the target group,
f) sending the electronic communication to the member of the target group, and
g) receiving a response from the member of the target group, wherein said response is passed through the privacy filter to associate the response with the unique customer key.

2. The method according to claim 1, further comprising creating the database by collecting a plurality of individual consumer data from a plurality of consumer data sources.

3. The method according to claim 1, wherein the step of analyzing the de-identified individual consumer data includes an assessment based on one or more parameters selected from the group consisting of gender, age, race, income level, purchasing, browsing, travel, banking, investing, work and television.

4. The method according to claim 1, further comprising requesting the member of the target group to participate in a focus group designed based on the member's response to the survey.

5. The method according to claim 1, further comprising compensating the member for responding to the survey.

6. A system for designing a customer loyalty program comprising:
a) a database including de-identified individual consumer data,
b) a search page configured to receive a search query and return a list of individuals matching said query from said database to define members of a target group,
c) a privacy filter for keeping confidential each individual's identifying characteristics from the researcher until said individual authorizes disclosure of said individual's identifying characteristics,
d) a survey provided to a member of the target group for identifying potential barriers to customer loyalty program participation, and
e) a survey receiver for collecting responses from the survey of the member of the target group.

7. The method according to claim 6, wherein the step of analyzing the de-identified individual consumer data includes an assessment based on one or more parameters selected from the group consisting of gender, age, race, income level, purchasing, browsing, travel, banking, investing, work, and television.

8. The system according to claim 6, wherein the privacy filter assigns a unique customer key to each individual's data in the database.

9. The system according to claim 6, further comprising a database for storing information on a member of a target group demonstrating interest in participating in a focus group in response to the survey.
